(19) United States
(12) Patent Application Publication
(10) Pub. No.: US 2008/0062843 A1
(43) Pub. Date: Mar. 13, 2008

(54) Mastering of an Optical Disc with a Data Pattern in the Form of a Metatrack Having Coplanar Parallel Sub-Tracks

(75) Inventors: Jacobus Hermanus Maria Neijzen, Eindhoven (NL); Marius Iosif Boamfa, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/576,544

(22) PCT Filed: Sep. 26, 2005
(86) PCT No.: PCT/IB05/53176

§ 371 Date: Apr. 3, 2007

(30) Foreign Application Priority Data
Oct. 8, 2004 (EP) 04104922.2

(51) Int. Cl. G11B 3/74

(52) U.S. Cl. 369/92

(57) ABSTRACT

A method and a device for writing data marks to an optical disc or a master disc are disclosed, the data marks to be arranged along at least one metatrack, which is formed by a number of coplanar parallel sub-tracks. The method comprises a step of superposing a rotational motion and a radial motion of the disc and of a writing beam spot on the disc relative to each other. The radial motion comprises a motion component in a first radial direction and periodically repeated jumps in a second radial direction opposite to the first radial direction. The radial motion is a superposition of a) a first radial motion component (18), by which the radial position of the writing beam spot as a function of the angular position with respect to the rotational motion is changed steadily with a first slope, and b) a periodic second radial motion component (20), one period of which, plotted as a function of said angular position, is divided into aa) a first interval (20.1), in which the radial position of the writing beam spot changes with a second slope either in the radial direction of the first radial motion component or in the radial direction opposite thereto, and bb) an adjacent second interval (20.2), in which the radial position of the writing beam spot on the disc changes in a radial direction opposite to that of the superposition of the first (18) and second radial motion components during the first interval (20.1), and with a third slope having an amount larger than the amount of the sum of the first and second slopes. Also disclosed is an optical disc or master disc produced by the method of the invention.

The present invention relates to a method and a device for writing data marks to an optical disc or a master disc, the data marks to be arranged along at least one metatrack, which is formed by a number of coplanar parallel sub-tracks. The invention further relates to an optical disc or a master disc having data marks arranged along a metatrack in the form of either a circular ring or a spiral, which is formed by a number of sub-tracks taking the form of coplanar parallel rings or subspirals, respectively.

Persistent-memory discs for optical read-out, referred to as optical discs, are known in the form of the Compact Disc (CD), Digital Versatile Disc (DVD) and, recently, BluRay Disc (BD). Driven by the need for a larger storage capacity, the density of data marks on an optical disc has grown with the advent of the two latter forms of optical discs. At the same time, the goal has been to increase the data rate during read-out in order to reproduce broadband multimedia data streams.

The data pattern of these known disc types consists of a continuous track of pits in the form of a spiral. Mastering of such disc types is relatively easy. Basically, a single writing beam spot with modulated intensity illuminates a resist layer on top of a rotating substrate. The spiral pattern is realized by slowly changing the radial position of the writing beam spot during the exposure.

As a way to further increase the data rate during read-out and at the same time increase the storage capacity of an optical disc, an optical disc format has been proposed with data marks arranged in a two-dimensional pattern along a broad spiral track consisting of a number of parallel coplanar sub-tracks. Such a broad spiral data pattern will also be referred to as a metaspiral. The use of this disc format concept is expected to result in a data capacity of the order of 50 Gigabytes for a disc of 12 cm diameter and a data rate of the order of 300 Megabit/second.

A summary of this project was published under http://www.extra.research.philips.com/euproject/twodos/summary.htm and is outlined in the following. The metaspiral track of an optical disc having this disc format is to be formed by a number of sub-tracks in the form of coplanar parallel subspirals, which are separated by a predetermined subspiral pitch. The data marks arranged along the parallel subspirals are to form a two-dimensional pattern on the disc, such as a honeycomb structure. Data marks in adjacent sub-tracks are to be read out in parallel by means of a number of reading beam spots. The light from the reading beam spots reflected by the two-dimensional data mark pattern on the disc is to be detected by a set of photo-detectors, which generate a set of high-frequency signal wave forms. The set of signal waveforms is to be used as an input to signal processing in order to reproduce the data stored on the disc.

It should be pointed out that the method and device features outlined above represent a technology concept. At present, there is no functioning mastering or writing technology, which is capable of producing optical discs with the disc format under consideration. In general, as is well known in the art, optical discs are made by either directly writing data marks sequentially into a special reflective layer of the disc with a writing beam, or by first writing data marks sequentially onto a master disc with a writing beam, and then using the master disc to impress the data marks onto a plastic blank disc, which is to be coated with a reflective coating and a lacquer layer afterwards to form an optical disc. The latter technique is used in commercial mass production of optical discs while the earlier technique is mostly used in consumer electronics devices and personal computers to create optical discs individually or in small number.

It is an object of the present invention to provide a method for writing data marks to an optical disc or to a master disc, with the data marks to be arranged along a metatrack, which is formed by a number of coplanar parallel sub-tracks. It is a further object to provide a device for writing data marks to an optical disc or a master disc of this disc format.

Since a description of the method aspect of the invention is more instructive, it will be presented first before turning to the device aspect of the invention.

According to a first aspect of the invention a method is provided for writing data marks to an optical disc or a master disc, with the data marks to be arranged along at least one metatrack, which is formed by a number of coplanar parallel sub-tracks.

The term metatrack is used here to differentiate it from the common concept of a single track without sub-tracks, as known from prior-art disc formats like the CD. The term sub-track is used here to underline its affiliation with a metatrack. A sub-track typically contains a one-dimensional arrangement of data marks, for example arranged as a sequence of data marks along a spiral or circular (imaginary) line. However, it is noted that within the framework of the present invention a guard band, which may take the form of a spiral or circular (imaginary) line without data marks arranged parallel to those having data marks, can also be understood as a sub-track.

The method comprises a step of superposing a rotational motion and a radial motion of the disc and of a writing beam spot on the disc relative to each other.

The radial motion comprises a motion component in a first radial direction and periodically repeated jumps in a second radial direction opposite to the first radial direction.

According to the method of the invention the radial motion just described is performed as a superposition of
a) a first radial motion component, by which the radial position of the writing beam spot as a function of the angular position with respect to the rotational motion is changed steadily with a first slope, and
b) a periodic second radial motion component, one period of which, plotted as a function of said angular position, is divided into
aa) a first interval, in which the radial position of the writing beam spot changes with a second slope either in the radial direction of the first radial motion component or in the radial direction opposite thereto, and
bb) an adjacent second interval, in which the radial position of the writing beam spot changes in a radial direction opposite to that of the superposition of the first and second radial motion components during the first interval, and with a third slope having an amount larger than the amount of the sum of the first and second slopes.

The method of the invention allows the production of a disc with a two-dimensional, precisely defined arrangement of data marks. An arrangement of data marks in parallel sub-tracks forms a two-dimensional data pattern, if the position of data marks along a sub-track, i.e., in a tangential direction, is defined in relation to the position of data marks in at least one adjacent sub-track. Such defined arrangements can be used to achieve a particularly high density of data marks on the disc. An example of a two-dimensional data pattern suitable for high-density data recording is a honeycomb arrangement of data marks in a plurality of sub-tracks forming a metatrack. Another example of a well defined two-dimensional arrangement of data marks is the production of a pattern forming label on a disc.

However, the method is not limited to the production of such well defined two-dimensional data patterns on a disc. The method can also be used to produce a disc having a metatrack with sub-tracks having data marks, which are not synchronized.

In the following, the radial motion and its two motion components will be explained in further detail. Like the rotational motion, the radial motion is defined generally as a motion of the disc and the writing beam spot on the disc relative to each other. That means, it can be implemented in different ways forming different embodiments of the method of the invention, depending on whether only the disc or only the writing beam spot or both are actually moved physically.

Furthermore, the radial motion according to the method of the invention is divided into two radial motion components superposing each other. By this concept, the most precise translation mechanism can be chosen to perform a particular radial motion component. It thus allows to allocate the two motion components to different translation mechanisms, for instance an electromechanical translation of device components carrying the disc or writing beam optics on one hand and an acousto-optical deflection of the writing beam on the other hand. The superposition of the first and second radial motion components means that both motion components are performed at the same time.

A steady first radial motion component allows to use a uniform radial translation velocity without any interruptions, which is an important factor in providing a precise alignment of data marks in adjacent sub-tracks with high density using a single writing beam. Plotted as a function of angular position of the writing beam spot on the disc, the radial position of the writing beam spot changes linearly with a first slope.

It should be noted that the angular position of the writing beam spot on the disc can be defined with respect to an angular reference position and is changed by the rotational motion.

The second radial motion component, plotted as a function of the angular position, is periodical. The second radial motion component is divided into two adjacent intervals in one period. The first and second intervals will also be referred to as the first and second phases of the second radial motion component. The length of the period of the second radial motion component is generally different from the period of the rotational motion. The second radial motion component may thus be repeated several times during one full turn of the rotational motion. It may, however, also be performed only once and in phase with the period of the rotational motion. Various embodiments will be given further below in order to elucidate the choices possible.

During the first interval, the radial position of the writing beam spot, again plotted as a function of angular position, changes with a second slope either in the radial direction of the first radial motion component or in the radial direction opposite thereto.

That means, in one embodiment the radial direction of the second radial motion component during the first interval is the same as that of the steady first radial motion component. During the first phase, the superposition of the steady first radial motion component and the second radial motion component results in a higher amount of the total slope, or, seen from another perspective, of the total translational velocity of radial motion in the first radial direction.

In an alternative embodiment, the radial direction of the second radial motion component during the first interval is opposite to that of the steady first radial motion component, resulting in a total slope of the radial motion with an amount given by the amount of the difference between the first and second slopes.

The resulting direction of the radial motion generated by this superposition of the first and second radial motion components during the first interval is referred to as the first radial direction.

During the second phase, which immediately follows the first phase, the resulting radial motion is opposite to that of the superposition of the first and second radial motion components during the first interval, i.e., in the second radial direction. In other words, the second phase of the second radial motion component exhibits a third slope of the change of radial position of the writing beam spot as a function of angular position, which has an amount larger than the amount of the sum of the first and second slopes, in order to result in a jump in the radial direction opposite to the first radial direction.

It is this second phase, during which the jump in the radial motion is performed. The second phase is thus typically chosen as short as technically possible, given the constraint that the jump must be reproducible to secure correct alignment of data marks. The amount of the slope is preferably as high as possible under these constraints in order to leave as little disc space unused as possible. For during the jump no data marks are written while the rotational motion is continued. Experiments show that a quasi-seamless continuation of sub-tracks can be achieved resulting in a negligible loss of disc space.

The combination of rotational and radial motion just described allows using a single writing beam for mastering a disc with a metatrack having a number of sub-tracks. As will be explained in further detail below, the method can easily be adapted to the number of sub-tracks used in a particular disc format by changing the slopes or periods of the first and second radial motion components.

The method of the invention overcomes the perception that it is necessary to use multiple writing beam spots for synchronously mastering multiple sub-tracks. In fact, using a number of writing beam spots corresponding to the number of sub-tracks metatrack for writing the data marks seems to be the natural choice. For a synchronous generation of data marks using multiple writing beam spots would, at least in theory, allow a precise alignment of data marks relative to each other in adjacent sub-tracks. Also, since all sub-tracks are written synchronously and continuously from the first to the last respective data mark without interruption, each sub-track could take the form of a perfect seamless spiral, thus allowing a set of reading beam spots to continuously follow the respective sub-tracks without having to make jumps during reproduction of the data. In contrast, a single writing beam spot must perform jumps between sub-tracks in order to cover all sub-tracks. The general notion has been that jumps of the writing beam spot are difficult to perform with the precision needed to write data marks in a density giving rise to a very high data storage capacity. Jumps of the writing beam spot, according to the previous general opinion, further create an unacceptable amount of unused disc space because they require a certain time during which the disc continues to turn with a high rotational speed required to achieve a high data rate during mastering. Unused disc space, however, makes it necessary also for the reading beam spots to make jumps during read-out, which can deteriorate the reproduction quality.

The method of the invention solves these anticipated problems of single-beam mastering of a disc format with a two-dimensional data pattern along one or more metatracks. The superposition of radial and rotational motion components according to the method of the invention described above allows the jumps of the writing beam spot to be performed with an accuracy and speed that assures precise alignment of data marks in adjacent sub-tracks while generating virtually no loss of disc space. Only very small interruptions of the data stream along the sub-tracks are needed, which can even be used during read-out to maintain radial alignment of the reading beam.

The method of the invention therefore opens a way to keep the construction complexity of a mastering machine for the particular disc format relatively simple without sacrificing the goals of high data density and high data rate associated with the particular disc format under consideration here. By employing the method of the invention, there is no need to provide and control a multitude of independent writing beam spots and to keep them aligned relative to each other with the required high accuracy.

In the following section, further preferred embodiments of the method of the invention will be described.

The method is preferably applied to the production of a metatrack in the form of a spiral having sub-tracks in the form of coplanar parallel subspirals. The method can also be used to create a ring-shaped metatrack having sub-tracks taking also the form of parallel circular rings.

Generally, the mastering or writing of the disc according to the method of the invention can be performed using a either constant linear velocity (CLV) or a constant angular velocity (CAV) of the rotational motion. Both modes are well known in the art. However, to realize a two-dimensional pattern with precisely aligned data marks in neighboring sub-tracks, the CAV mode is far more practical. Writing in a CAV mode with a constant channel bit time in combination with a fixed starting angle is the easiest way to maintain the synchronization or, in other words, correct alignment of data marks between sub-tracks. The radial jump in connection with the second radial motion component can for instance be performed at the fixed starting angle once per revolution.

However, in a first preferred embodiment of the method of the invention the angular velocity of the rotational motion is adjusted periodically so as to keep a channel bit time of the data marks either constant or nearly constant with respect to the changing radial position of the writing beam spot on the disc. Typically, the angular velocity will be adjusted stepwise after a predetermined number of tracks in order to compensate for the increased radius. This way, the channel bit time as well as the writing velocity is kept almost perfectly constant. This mode may therefore be called “quasi constant linear velocity” (QCLV) mode.

There are two alternative embodiments for producing a guard band. A guard band generally is a non-recorded band between adjacent sub-tracks or adjacent metatracks. A guard band or guard band section can be produced on the disc by not writing data marks during one full period of the second radial motion component while continuing the rotational motion and the radial motion.

In an alternative embodiment, the radial distance bridged during the second interval of the second radial motion component is controlled to take on a smaller first distance value when performing a jump to a different sub-track with data marks within a metatrack and to take on a lager second distance value to perform a jump to a neighboring sub-track or metatrack to form a guard band or guard band section. This provides a faster way than continuing the rotational and radial motions of the writing beam spot with a decreased intensity or with the writing beam being switched off. In a generalization of this embodiment, the radial distance bridged during the second interval of the second radial motion component is controlled to periodically take on a plurality of radial distance values. This way a metatrack with various sub-track pitches can be produced.

In both cases the length of the guard band section depends on the frequency of radial jumps of the writing beam spot per full turn of the disc according to the method of the invention. If there is only one radial jump per full turn, a guard band is produced in one step. If there are two or more radial jumps per full turn, a guard band is produced as a sequence of guard band sections during a number of consecutive full turns of a disc.

The first mentioned embodiment for producing a guard band by “writing” an empty sub-track is advantageous in combination with the QCLV mode described above. According to a special case of this embodiment the angular velocity in the QCLV operation is adjusted when a guard band section is produced. Adjusting the angular velocity during production of a guard band or guard band section is advantageous because there is enough time to perform the adjustment without affecting the process of writing data marks at all.

In choosing an amount for the slopes of the first and second radial motion components it should be considered that the alignment of data marks is the better the smaller the jump is, which the writing beam spot has to make when changing the sub-track. In one embodiment of the method of the invention, the first slope of the first radial motion component amounts to one sub-track pitch per full turn of the rotational motion. This value of the slope also avoids a more complicated non-uniform second radial motion component. The first radial motion component is preferably perfectly linear in order to ensure a precise alignment of data marks in the radial direction. Deviations from a perfect linearity are only acceptable if they are small.

It should be noted that there are several alternative embodiments for implementing a suitable superposition of the first and second radial motion components. In a preferred embodiment, the radial directions of the first radial motion component and of the first interval of the second radial motion component are identical. This allows to produce a spiral-shaped metatrack with a number of sub-tracks in the form of parallel coplanar subspirals.

In an alternative embodiment, the radial directions of the first radial motion component and of the first interval of the second radial motion component are in opposite radial directions. Two special cases of this embodiment will be described in the following two paragraphs.

In a first special case of this alternative embodiment the amounts of the first and second slopes are identical. A metatrack in the shape of a concentric ring can be produced this way. The jump during the second interval of the second radial motion component carries the writing beam spot form sub-track to sub-track. Such a metatrack shape is not very interesting for data read-out, but for sensor applications.

In a second special case of the alternative embodiment the second slope is larger than the first slope. In this case a metatrack in the form of a spiral is produced. In comparison to the preferred embodiment exhibiting identical radial directions, the resulting radial direction of the superposition is opposite here. Specifically, while it is generally preferred to start writing near the center of the metatrack and head towards the outer circumference of the disc, the present special case allows to work in the opposite direction, that is, start at the outer circumference and move towards the center of the metatrack. Another use of the present embodiment is an inversion of the direction of the spiral. This is advantageous in writing dual layer discs. By using the present embodiment for this application, the rotation direction of a rotation stage of a mastering machine or the direction of a translation stage of the mastering machine need not be inverted for writing the second layer of data marks. This would be difficult to do in presently known liquid-immersion mastering equipment.

The radial distance bridged during the jump of the writing beam spot, i.e., the second interval of radial motion of the second radial motion component, preferably ranges between the momentaneous radial distance between the writing beam spot and an adjacent sub-track next to be written, and a radial distance defined by the sum of one metatrack pitch minus or plus one sub-track pitch. The “minus” applies to the preferred embodiment, in which the first and second radial motion components are in the same radial direction. The “plus” applies to the alternative case of opposite radial directions. The radial distance to be bridged by the jump of the writing beam spot is more difficult to realise with the required precision if it spans a larger number of sub-tracks. Therefore, a smaller value of the second slope of the first interval of the second radial motion is preferred.

A smaller radial distance bridged by the jump requires a proper increase of the number of jumps per full turn of the rotational motion in order to cover all sub-tracks. Accordingly, the jump frequency is between one jump and a number of jumps given by the number of sub-tracks within a metatrack minus or plus one, counted per full turn of the rotational motion. Again, the “minus” case applies to identical radial directions of the first and second radial motion components during the first interval, and the “plus” case applies to opposite radial directions.

In a preferred embodiment of the method of the invention the second radial motion component is implemented by acousto-optically deflecting a laser beam, which forms the writing beam spot. Acousto-optical deflection can be performed with the required speed and precision to achieve a seamless or nearly seamless continuation of a given sub-track after a jump from a previously mastered sub-track. It is for instance possible to translate the writing beam spot in a radial direction over one sub-track pitch of 200 nanometers within about 50 nanoseconds. Given a linear velocity of the writing beam spot on the disc of several meters per second this implies that the writing beam spot is moved only about 200 nanometers during the jump in the tangential direction.

In order to completely avoid interruptions in the data stream, in a further embodiment the rotational motion comprises
a steady rotational motion component having a first turning sense and
periodically repeated jumps having a second turning sense opposite to the first turning sense,

wherein the jumps in the rotational motion are performed at the same time as the jumps in the radial motion. In this embodiment, the rotational motion is performed as a superposition of two components as well. The backward jumps in the second turning sense, typically small and therefore along a current tangential direction of the subspiral tracks, serve to compensate the distance along the track, which is spanned during the jumps of the second radial motion component.

The rotational jumps can be realized in analogy to the radial jumps. In a further embodiment the rotational motion is a superposition of a continuous first rotational motion component, by which the angular position of the writing beam spot as a function of time is changed with a first angular velocity component, and a sawtooth-shaped second rotational motion component. During the first interval of radial motion, the sawtooth-shaped second rotational motion component is directed in the first turning sense with a second angular velocity component, and, during the second interval of radial motion, the sawtooth-shaped second rotational motion component is directed in the second turning sense with a third angular velocity component larger than the sum of the first and second angular velocity components.

According to a second aspect of the invention, a device for writing data marks to an optical disc or a master disc is provided, comprising

a disc holding unit,

a writing unit adapted to generate a writing beam having a modulated intensity and to focus a writing beam spot on a disc positioned in the disc holding unit,

a rotation unit adapted to generate a rotational motion of the disc holding unit and of the writing beam spot relative to each other,

a translation unit adapted to generate a radial motion of the disc holding unit and of the writing beam spot relative to each other, and

a control unit adapted to generate and provide control signals to drive the operation of the writing unit, of the rotation unit, and of the translation unit such that the data marks are written along a spiral track, which is formed by a number of coplanar parallel sub-tracks.

The control unit is further adapted to control the operation of the translation unit and of the rotation unit in generating a superposition of a rotational motion and a radial motion of the disc and of the writing beam spot on the disc relative to each other. The radial motion comprises a motion component in a first radial direction and periodically repeated jumps in a second radial direction opposite to the first radial direction. The radial motion is a superposition of
a) a first radial motion component, by which the radial position of the writing beam spot as a function of the angular position with respect to the rotational motion is changed steadily with a first slope, and
b) a periodic second radial motion component, one period of which, plotted as a function of said angular position, is divided into
aa) a first interval, in which the radial position of the writing beam spot changes with a second slope either in the radial direction of the first radial motion component or in the radial direction opposite thereto, and
bb) an adjacent second interval, in which the radial position of the writing beam spot changes
in a radial direction opposite to that of the superposition of the first and second radial motion components during the first interval,
with a third slope having an amount larger than the amount of the sum of the first and second slopes.

The device of the invention is adapted to perform the method of the invention. It has a simple structure in that the relative motion of only one writing beam and the disc has to be controlled. Further advantages of the device of the invention correspond to that of the method of the invention.

In the following, preferred embodiments of the device of the invention will be described. Most embodiments correspond to an embodiment of the method of the invention. The description is therefore kept short. For respective details and advantages, reference is made to the above description of the embodiments of the method of the invention.

In a first embodiment of the device of the invention the control unit is further adapted to periodically drive the rotation unit to adjust the angular velocity of the rotational motion so as to keep a channel bit time of the data marks either constant or nearly constant with respect to the changing radial position of the writing beam spot on the disc. This device embodiment implements the quasi constant linear velocity (QCLV) mode explained in the context of an embodiment of the method of the invention. Preferably, in this context, the control unit is adapted to drive the rotation unit to adjust the angular velocity when driving the writing unit to produce a guard band section comprising at least one full period of the second radial motion component without data marks.

In another embodiment the control unit is adapted to control the amount of the second slope of the first interval of the second radial motion component to maintain a predetermined value of at least one subspiral pitch and per full turn of the rotational motion.

In another embodiment the translation unit comprises an acousto-optical beam deflection unit, which is connected to the writing unit and to the control unit. The acousto-optical beam deflection unit is adapted to deflect the writing beam so as to move the writing beam spot on the disc in the first and second radial directions. The control unit is further adapted to drive the acousto-optical beam deflection unit so as to implement the second radial motion component by acousto-optical deflection of the writing beam alone.

In another embodiment the control unit is adapted to control the acousto-optical deflection unit to translate the writing beam spot over a predetermined radial distance during the second interval of the second radial motion component, said radial distance ranging between the momentaneous radial distance to an adjacent sub-track next to be written and the sum of one metatrack pitch minus or plus one sub-track pitch. As for the case differentiation between “minus” and “plus”, reference is made to the corresponding embodiment of the method of the invention. The smallest momentaneous radial distance to an adjacent sub-track next to be written is one sub-track pitch. In a spiral-shaped metatrack there may be a small difference to the exact value of one sub-track pitch, caused by the continued rotational motion during the jump. However, since the distance bridged during the jump along the sub-track in the tangential direction is typically about 200 nanometer, the corresponding decrease in the radial distance to be bridged is negligible.

In a further embodiment the control unit is adapted to provide control signals to acousto-optical deflection unit to perform the jumps with a frequency from a range of values between one and the sum of the number of sub-tracks contained in the metatrack minus or plus one, counted per full turn of the rotational motion. Again, the case differentiation between “minus” and “plus“was explained in the context of the corresponding embodiment of the method of the invention.

In another embodiment the control unit is adapted to provide control signals instructing the acousto-optical deflection to periodically change the radial distance bridged during the second interval of the second radial motion component between at least two distance values. This embodiment allows guard bands to be produced by performing radial jumps over a larger distance.

In order to minimize the interruption of the sub-tracks caused the jumps of the writing beam spot the control unit is in one embodiment adapted to drive the rotation unit to generate the rotational motion comprising
a continuous first rotational motion component having a first turning sense and
periodically repeated jumps having a second turning sense opposite to the first turning sense,
   and wherein the control unit is further adapted to drive the rotation unit and the translation unit to generate the jumps in the rotational motion and the jumps in the radial motion at the same time.

In a further embodiment, the rotation unit is integrated into the disc holding unit such that the rotational motion is performed by rotating the disc against the writing unit. In this embodiment, which has been used for implementing the invention in a laboratory setup, the translation unit is adapted to radially translate a part of the writing unit containing containing a focussing objective lens with respect to the rotation unit. In this setup, beam intensity modulators, the acousto-optical deflector and a deep ultraviolet laser are fixed. However, in an alternative embodiment the also the modulation, deflection and focussing stages are translated. In a further embodiment, the writing beam source is a semiconductor laser, preferably in the blue or ultraviolet spectral range. This type of laser is easily integrated into the writing unit and can also be translated. A further alternative embodiment has the rotation unit mounted on a translation stage, thus keeping the complete optical system at a fixed position and only moving the disc. As can be seen from these various embodiments, the implementation of the method and device of the invention is not limited to a particular setup.

According to a third aspect of the invention, an optical disc or a master disc is provided having data marks arranged along a metatrack, which is formed by a number of coplanar parallel sub-tracks, wherein the data marks are generally arranged along a respective sub-track with at least one regular first distance between adjacent data marks, as measured along a respective sub-track, and wherein the sequence of data marks in each sub-track is interrupted periodically with a frequency of at least one interruption per full turn of the disc, the interruption being formed by a larger second distance between two adjacent data marks than the respective regular first distance.

The disc of the third aspect of the invention is the product of the method of the invention. It allows a fast parallel read-out of data marks synchronized without requiring the reading beams to perform jumps to follow the sub-tracks. It exhibits characteristic periodic interruptions in the sequence of data marks along each sub-track of a metatrack. The interruptions are generated during radial jumps of the writing beam spot on the disc. Typically, the larger second distance is of the order of one channel bit length. A numerical example of the second distance is about 200 nanometer.

In a preferred embodiment of the disc the data marks are arranged in a two-dimensional honeycomb grid. This way a particularly high density of data marks can be achieved, corresponding to a high storage capacity of the disc. The honeycomb grid represents an imaginary template for the arrangement of the data marks. Of course, only the data marks are visible on the disc. Imaginary hexagonal cells of the honeycomb grid are either “filled” with a data mark or empty, where no data mark is written to a particular cell.

In the following, further preferred embodiments of the invention will be described with reference to the figures.

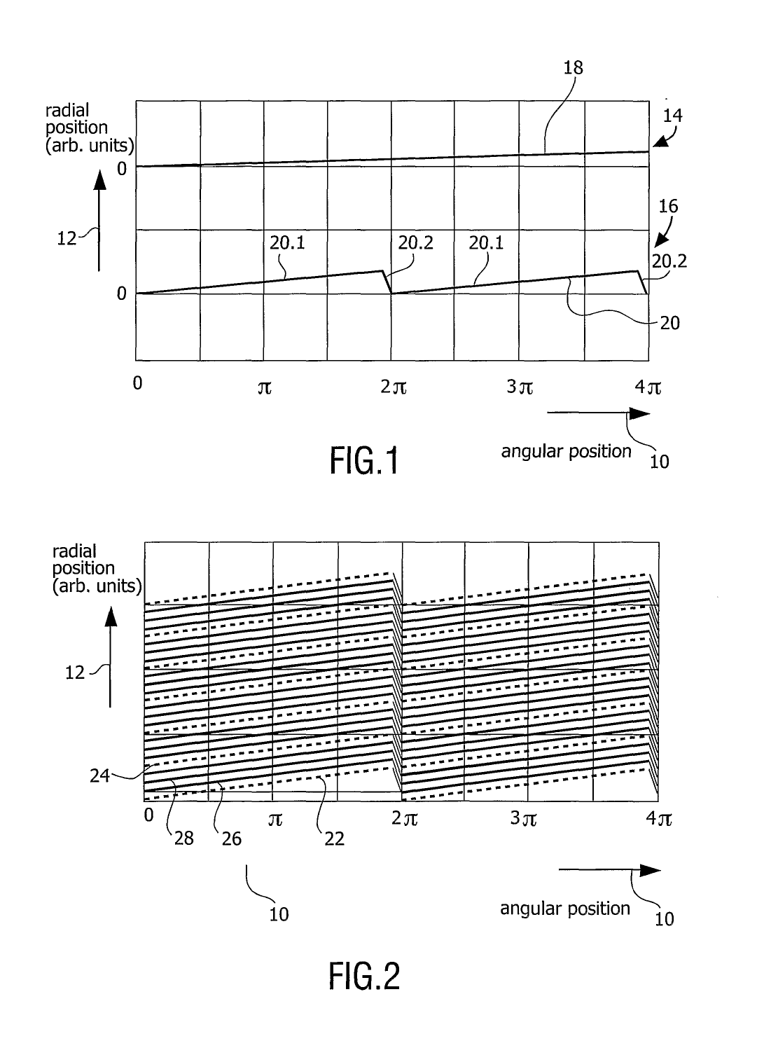

FIG. 1 shows in a diagram for a first embodiment the radial displacements of a writing beam spot on the disc induced by the first and second radial motion components as a function of the angular position of the writing beam spot on the disc

FIG. 2 shows for the embodiment of FIG. 1 a diagram with a representation of the total radial displacement of the writing beam spot resulting from the first and the second radial motion components.

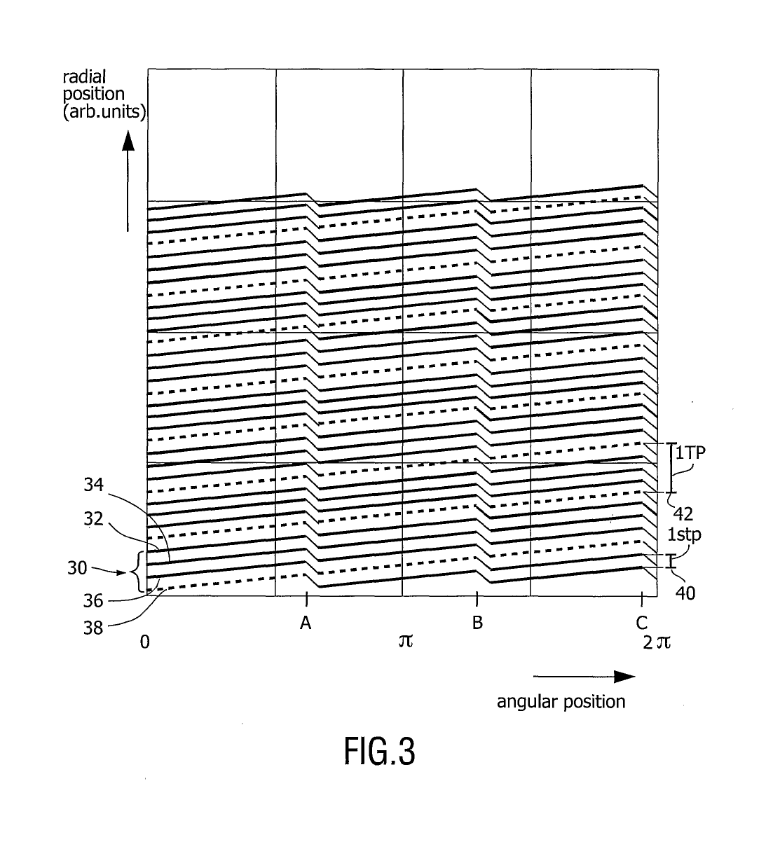

FIG. 3 shows in a diagram the total radial displacement of the writing beam spot resulting from the first and the second radial motion components for a second embodiment.

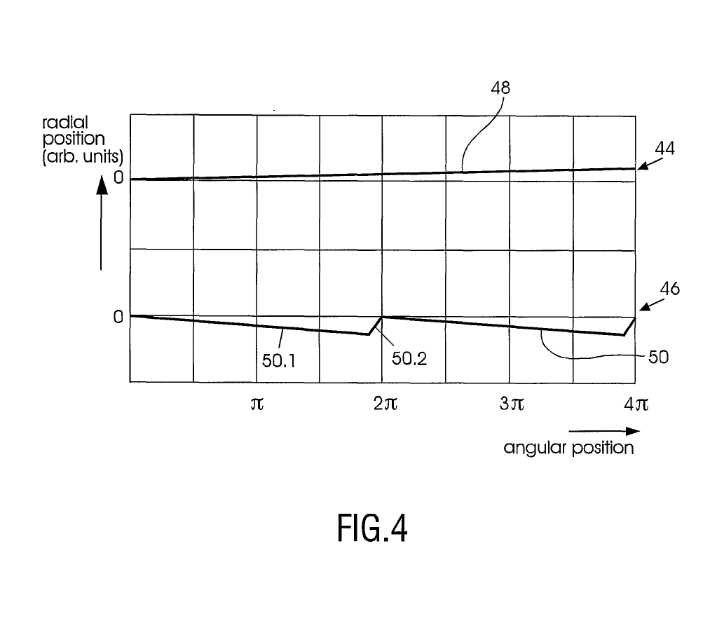

FIG. 4 shows in a diagram for a third embodiment a representation of the radial displacements of a writing beam spot on the disc induced by the first and second radial motion components as a function of the angular position of the writing beam spot on the disc.

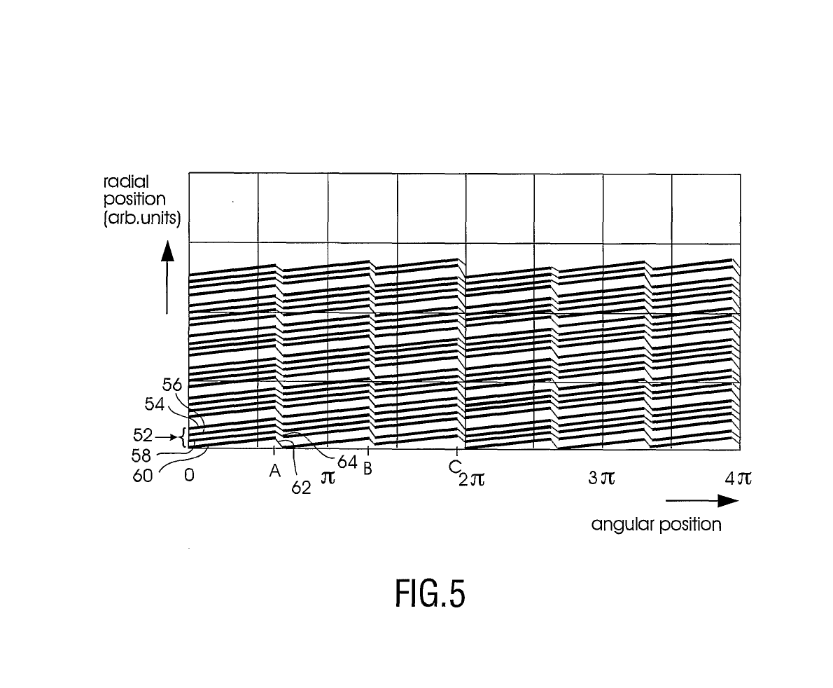

FIG. 5 shows in a diagram for a fourth embodiment a representation of the total radial displacement of the writing beam spot resulting from the first and the second radial motion components.

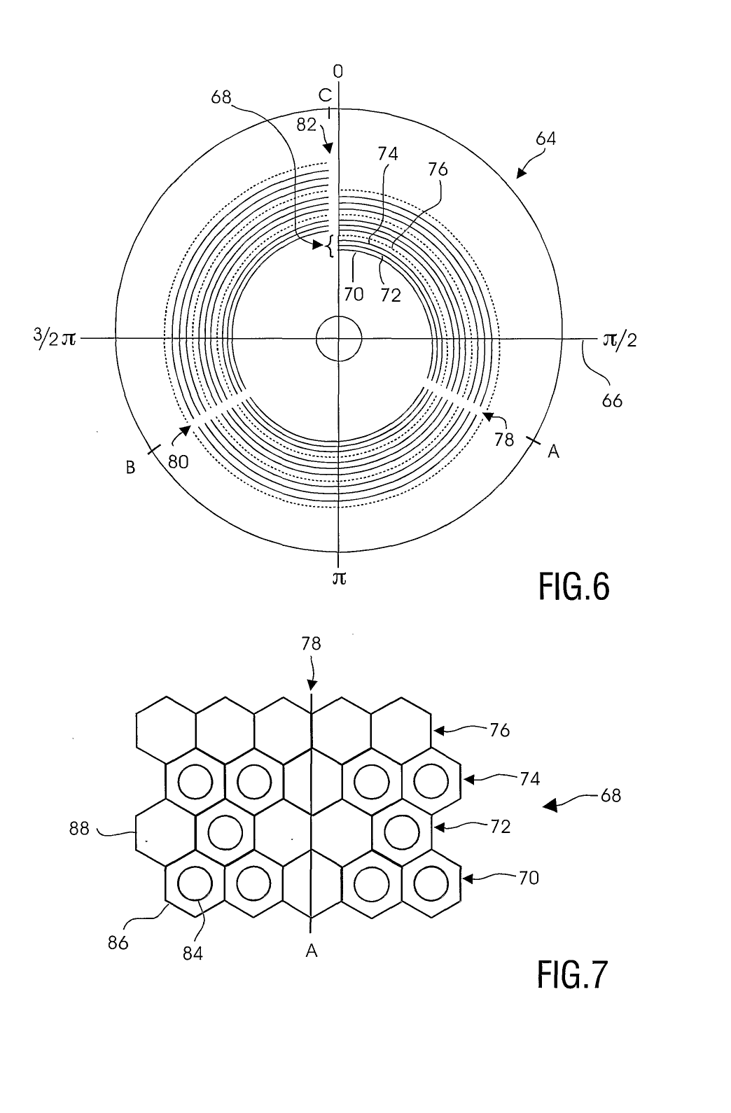

FIG. 6 shows an embodiment of a disc with a spiral metatrack.

FIG. 7 shows an arrangement of data marks in the metatrack of the disc of the embodiment of FIG. 6.

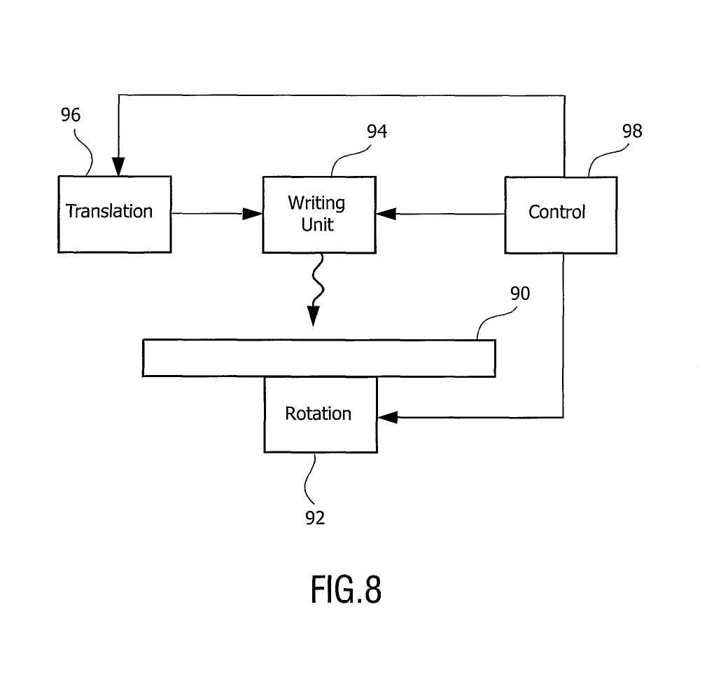

FIG. 8 shows an embodiment of a mastering machine.

FIG. 1 illustrates the first and second radial motion components superposed during the production of a disc with a metatrack in the form of a spiral with parallel coplanar subspirals. FIG. 1 shows a schematic diagram of the radial displacement of a writing beam spot on a master disc or an optical disc as a function of the angular position of the writing beam spot.

The direction of the abscissa is indicated in FIG. 1 by an arrow 10. The reference point for the determination of the angular position is arbitrarily chosen to be at the beginning of the writing process. The direction of the ordinate is indicated by an arrow 12. The radius is given in arbitrary linear units. The ordinate is divided into two sections 14 and 16, each having its own radial reference position marked “0” on the left side of the diagram. The sections 14 and 16 serve to visualize the dependence of the first and second radial motion components of the writing beam and of the disc relative to each other on the angular position.

The rotational motion of the disc and the writing beam spot relative to each other represented by the angular position along the abscissa is typically defined by a rotation axis passing through the center of the spiral track and standing perpendicular on the disc surface. It can be implemented in alternative embodiments by rotating the disc or by rotating an optical head generating the writing beam spot, or by rotating both. It is preferred to rotate the disc alone using a rotation stage in an Laser or Electron Beam Recorder (LBR, EBR). The turning sense of the rotational motion is chosen according to the turning sense of the spiral track.

The radial motion is in the spiral plane and perpendicular to the spiral and its subspirals. The radial motion can either be performed by the disc or the writing beam spot or both. For the purposes of the present embodiment the radial motion is performed by the writing beam spot alone and not by the disc. Also, for simplicity of the following description an embodiment will be described, according to which the first radial motion component 14 is performed by a translation stage of an LBR or EBR holding an objective lens that focusses the writing beam spot onto the disc and that the second radial motion component is performed by acousto-optically deflecting a laser writing beam.

Referring again to FIG. 1, the first radial motion component shown in section 14 is represented by a straight line 18 and thus corresponds to a linear increase of radial displacement. The linear increase of the radial displacement caused by the first radial motion component has a first slope, which is given by the value of the radial displacement at an angle of 2π, divided by 2π. It will be assumed that the slope amounts to one sub-track pitch per revolution, which is shortly written as 1 stp/2π.

The second radial motion component shown in section 16 of the diagram of FIG. 1 is more complicated, as can be seen by the shape of the corresponding trace 20. The trace 20 has the general appearance of a periodic sawtooth with a period of 1 per revolution, or 1/(2π). Each period of the sawtooth trace is divided into two sections, indicated by reference signs 20.1 and 20.2.

The first section 20.1 spans an angular interval of almost 2π, while the second section 20.2 covers only the remaining angular interval to complete a full period of 2π. It is noted that the angular interval covered by the second section 20.2 is strongly exaggerated in this and the following figures. In reality, the angle covered by the second section 20.2 corresponds to about one channel bit length. The first section 20.1 of the trace 20 represents a linear radial displacement of the writing beam spot with a second slope, which is assumed to have a value of 3 stp/2π.

The second section 20.2 of trace 20 is directed in a radial direction opposite to that of the first section 20.1 and that of the first radial motion component 18. Therefore, the sign of the third slope is opposite to that of the first and second slopes. Also, the amount of the third slope characterizing this section is larger than the amount of the sum of the first and second slopes. However, the jump performed in the second section 20.2 is best described by the radial distance bridged before the next period of the second radial motion component starts. In the present example the bridged radial distance is 3 stp. In order to ensure a precise continuation of sub-tracks the jump during section 20.2 should be over a radial distance exactly compensating the radial distance contributed to the radial motion by the component 20 during section 20.1.

The two radial motion components 18 and 20 are superposed in the process of writing a master disc or an optical disc.

FIG. 2 shows a diagram of the radial displacement of a writing beam spot on a disc surface resulting from the superposition of the first and second radial motion components 18 and 20 shown in FIG. 1. The diagram further differs from that of FIG. 1 in that it shows the radial displacement over a larger number of full turns of the rotational motion folded into angular intervals of 2π and duplicated for illustration purposes into the interval between 2π and 4π. This way it is possible to visualize the continuation of the individual sub-tracks of a metaspiral data pattern, as will be explained in the following. However, it should be noted that for following the movement of the writing beam spot only the angular interval between 0 and 2π is to be considered.

In the diagram of FIG. 2, there are dashed lines and full lines. The dashed lines, for example the dashed lines 22 and 24 indicate that the writing beam spot is switched to a low intensity, which will not produce data marks in a master disc or an optical disc. This way, the metaspiral pattern produced comprises one spiral-shaped sub-track forming a guard band.

The full traces, such as the traces 26 and 28 represent sections of radial motion of the writing beam spot, during which data marks are written to the sub-tracks. As can be seen from FIG. 2, the metaspiral written with the aid of the superposition of the two radial motion components shown in FIG. 1 consists of four parallel subspirals, one of which forms a guard band. The resulting slope of the superposition of the first and second radial motion components is 4 stp/2π. The radial distance between two full lines corresponds to one sub-track pitch, or 1 stp. The radial distance between two dashed lines corresponds to the track pitch of the metaspiral.

In the embodiment shown in FIGS. 1 and 2 the jump of the writing beam is performed at the fixed starting point of rotational motion, i.e., at zero angle. This is useful in a situation where data marks of adjacent sub-tracks have to be arranged in precisely defined two-dimensional data mark patterns, which are to be read out by multiple reading beams. For the metaspiral of FIGS. 1 and 2 at least three reading beams are needed. It is noted that the number of sub-tracks can be chosen according to the given needs and possibilities. Metaspirals with up to eight sub-tracks have been realized so far.

After a number of tracks, it is advantageous to stepwise adjust the angular velocity to compensate for the increased radius. This cannot be shown in the figures. This adjustment makes it possible to keep the channel bit time as well as the writing velocity almost perfectly constant. This approach is the QCLV mode described earlier. If possible it is advantageous to adjust the angular velocity during the “writing” of the empty guard-band.

FIG. 3 shows a diagram similar to that of FIG. 2, representing an alternative embodiment of the method and the device of the invention. Again, the radial displacement is shown as a function of angular position of the writing beam spot on the disc. Consecutive full periods of the change of angular position are again folded into the interval between 0 and 2π. However, in contrast to FIG. 2, only the relevant angular section between 0 and 2π is displayed. According to FIG. 3, a metatrack 30 in the form of a spiral with four sub-tracks 32, 34, 36, and 38 is produced. Sub-track 38 forms a guard band (dashed lines), the three sub-tracks (full lines) 32, 34, and 36 contain data marks. The distance of 1 stp is indicated by a vertical bar 40 on the right side of the diagram. Also shown is a second vertical bar 42 indicating the track pitch (1 TP) between identical sub-tracks in adjacent turns of the metatrack 30.

In the embodiment of FIG. 3, the first radial motion component is performed with a slope of 1 stp/2π, and the second radial motion component during its first phase is performed with a slope of 3 stp/2π. Instead of jumping over three sub-tracks once per revolution, as in the embodiment of FIGS. 1 and 2, the writing beam spot jumps three times per revolution over just one sub-track pitch at angular positions A, B, and C indicated on the abscissa of the diagram. Angular positions A, B, and C are at 2π/3, 4π/3 and 2π, neglecting again the very small angular intervals needed for the jumps. The maximum beam deflection amplitude of the first section of the second radial motion component during one period is 1 stp. The consequence of this approach is that the data stream to be written to the disc has to be subdivided into smaller blocks, and that a somewhat larger fraction of the disc area will be needed to jump and continue the data stream. Nevertheless, it remains a negligible fraction of the total disc area.

Another consequence of the present embodiment is that the cycle time of writing data sub-tracks and guardband sub-tracks is reduced from one change per revolution to several changes per revolution. This makes it more difficult to use the time interval of writing a guard-band for adjustments of the angular velocity. So, it may be attractive in that case to add specific empty tracks after a relatively large number of sub-tracks, in order to adjust the angular velocity.

FIG. 4 shows in a diagram similar to that of FIG. 1 first and second radial motion components, representing an alternative embodiment of the method and of the device of the invention, respectively. Again, a first radial motion component is shown in an upper section 44 of the diagram and is represented by a trace 48, and a second radial motion component is shown in a lower section 50 and is represented by a trace 50. The following description concentrates on the differences to the embodiment of FIG. 1. In contrast to the embodiment of FIG. 1, during the first interval the second radial motion component, which is performed by an acousto-optical deflection of the writing beam, is directed in an opposite radial direction compared to the first radial motion component, as indicated by the negative slope of the trace section 50.1. The second interval 50.2, i.e., the radial jump, is directed in the same direction as the first radial motion component.

While the slope of the first radial motion component 48 is 1 stp/2π as in the embodiment of FIG. 1, the slope of the second radial motion component 50 is 2 stp/2π. Jumps are performed with a frequency of 1/2π. In this embodiment, the resulting radial motion is reversed in comparison to that of FIG. 1. Assuming that the spiral metatrack of the embodiment of FIG. 1 is written from the inner to the outer circumference of a disc, the spiral metatrack of the present invention is written from the outer to the inner circumference.

FIG. 5 shows in a diagram similar to that of FIG. 2 another embodiment of the method and the device of the present invention, respectively. Again, the radial displacement is shown as a function of angular position of the writing beam spot on the disc. The total radial beam displacement is the superposition of the first radial motion component in the form of a linear stage translation and of the second radial motion component in the form of a periodic acousto-optical sawtooth deflection of the writing beam spot on the disc.

According to FIG. 5, a metatrack 52 in the form of a spiral with four sub-tracks 54 to 60 is produced. As in the embodiment of FIG. 3, the writing beam spot jumps three times per revolution over one sub-track pitch at angular positions A, B, and C indicated on the abscissa of the diagram. Angular positions A, B, and C are again at 2π/3, 4π/3 and 2π.

In contrast to the previous embodiments, the guard band is created in this embodiment by giving particular deflector jumps a larger second radial distance than a smaller first radial distance of 1 stp used between adjacent data tracks within the metaspiral. The larger second radial distance bridged during the second interval of the second radial motion component in this embodiment is for instance 5/3 stp. This guard-band jump interval is shown by way of example in FIG. 5 at reference sign 62, pointing to a trace section at jump position A. A sub-track jump interval is shown by way of example at reference sign 64, one full turn of the disc after the guard-band jump at reference sign 62.

The radial distance between the guard bands forms the track pitch of the metaspiral, which is 14/3 stp in this example. The radial distance between two data tracks within the metaspiral is one sub-track pitch or 1 stp.

It is noted that the period of the second radial motion component can be longer than 2π without influencing the first radial motion component. In the present embodiment the period of the second radial motion component performed by acousto-optical deflection of the writing beam is 4/3×2π. The writing beam returns to the same subtrack after a rotational motion of 4/3×2π. The linear first radial motion component is performed independently by a translation stage.

FIG. 6 shows a schematic sketch of an embodiment of a disc of the invention, which is produced by the method of the invention. For ease of illustration, the disc is drawn into a coordinate system 66 to be used for indicating angular positions.

The disc 64 has a metatrack 68 in the shape of a spiral having four spiral sub-tracks 70, 72, 74, and 76. Sub-track 76, indicated by a dashed spiral, forms a guard band. Of course, the metatrack 68 is enlarged and not drawn to scale. Except for the position of the guard band in the order of the sub-tracks, the disc format of the disc 64 corresponds to that produced by the embodiment of the method of the invention explained in the context of FIG. 5.

On the outer circumference of the disc 64, three angular positions A, B, and C are indicated. At these angular positions, the metatrack has interruptions 78, 80, and 82, respectively, which are indicated by the interruptions of the traces 70 to 76 representing the sub-tracks. The interruptions 78, 80, and 82 are also strongly enlarged for illustrative purposes. As explained in the context of previous embodiments, the interruptions are caused by jumps of a writing beam spot on the disc during the producting of the disc 64 or its master disc.

FIG. 7 shows a schematic diagram of a metatrack section of the disc 64 at the angular position A indicated in FIG. 6. Also indicated are the sub-tracks 70 to 76 and interruption 78. In FIG. 7, data marks are indicated by open circles, for instance at reference sign 84. Also shown is a honeycomb grid consisting of adjacent hexagonal cells. One example of a hexagonal cell is shown at position 86. It contains data mark 84. Another hexagonal cell is shown at position 88. It does not contain a data mark.

The metatrack 68 is continued to the left and right hand side of the section shown in FIG. 7. Data marks, if present, are arranged in the center of respective hexagonal cells. The resulting two-dimensional data mark pattern exhibits a particularly high density of data marks.

As shown in FIG. 7, at angular position A none of the sub-tracks has a data mark because of the interruption 78 caused by a radial jump of the writing beam. In sub-tracks 70 and 74, one hexagonal cell is left empty, in sub-track 72 two adjacent hexagonal cells are left empty.

FIG. 8 shows a simplified block diagram of an embodiment of a mastering machine of the invention. The masterin machine has a disc support 90 connected to a rotation stage 92. At a distance to the disc support there is a writing unit 94, which is connected to a translation stage 96. A control unit is connected to the rotation stage, the translation stage and the writing unit.

The rotation stage generates a rotational motion of the disc support 00. The writing unit 94 generates a writing beam having a modulated intensity according to the sequence of data marks to be written to a disc positioned on the disc support 90. The writing beam is focussed to a writing beam spot on a disc positioned in the disc support 90. Writing unit 94 also contains an acousto-optical deflection stage (not shown). The continuous radial translation motion of the writing unit 94 generated by the translation stage 96 should be almost exactly linear, just as in the case of a simple single track spiral. Systematic periodic deviations of the translations stage position coupled to the angular position of the rotation unit 92 could even be accepted, but are unlikely. The radial jumps generated by the acousto-optical deflection stage must be reproducable.

To obtain a desired high density of data marks, the writing beam generated by the writing unit 94 is an UV laser beam. In a mastering machine, an immersion technique can be used in combination with an UV laser beam for the production of the master disc in order to further increase the data density. For a mastering machine, an electron beam is an alternative choice to a UV laser beam.

The control unit 98 controls the operation of the translation stage 96 and of the rotation stage 92 in generating the superposition of a rotational motion and a radial motion of the disc and of the writing beam spot on the disc relative to each other, which has been described in the context of the embodiments of FIGS. 1 through 7, and of other embodiments above.

It should be noted that the invention is especially suitable for the generation of a high-density data pattern on an optical disc or a master disc, but not restricted to that. Other wavelengths of a writing beam may be used resulting in a lower density. Also, the spacings between data marks and subspirals may be chosen to be larger than that described above. Furthermore, the invention is also applicable to the generation of conventional one-dimensional data patterns for serial read-out.

1. A device for writing data marks(84) to an optical disc or a master disc (64), comprising
a disc holding unit (90)
a writing unit (94) adapted to generate a writing beam having a modulated intensity and to focus a writing beam spot onto a disc to be held by the disc holding unit (90),
a rotation unit (92) adapted to generate a rotational motion of the disc (90) and of the writing beam spot relative to each other,
a translation unit (96) adapted to generate a radial motion (18, 20; 48, 50) of the disc holding unit (90) and of the writing beam spot relative to each other, and
a control unit (98) adapted to generate and provide control signals to drive the operation of the writing unit (94), of the rotation unit (92), and of the translation unit (96) such that the data marks are written along a metatrack (30, 52, 68), which is formed by a number of coplanar parallel sub-tracks (32-38, 54-60, 70-76),
wherein the control unit (98) is adapted to control the operation of the translation unit (96) and of the rotation unit (92) in generating a superposition of a rotational motion and a radial motion of the disc and of the writing beam spot on the disc relative to each other,
wherein the radial motion comprises a motion component in a first radial direction and periodically repeated jumps in a second radial direction opposite to the first radial direction, and
wherein the radial motion is a superposition of
a) a first radial motion component (18, 48), by which the radial position of the writing beam spot on the disc as a function of the angular position with respect to the rotational motion is changed steadily with a first slope, and
b) a periodic second radial motion component (20, 50), one period of which, plotted as a function of said angular position, is divided into
aa) a first interval (20.1, 50.1), in which the radial position of the writing beam spot on the disc changes with a second slope either in the radial direction of the first radial motion component or in the radial direction opposite thereto, and
bb) an adjacent second interval (20.2, 50.2), in which the radial position of the writing beam on the disc spot changes
in a radial direction opposite to that of the superposition of the first (18, 48) and second radial motion components during the first interval (20.1, 50.1),
with a third slope having an amount larger than the amount of the sum of the first and second slopes.

2. The device of claim 1, wherein the control unit (98) is adapted to periodically drive the rotation unit (92) to adjust the angular velocity of the rotational motion so as to keep a channel bit time of the data marks either constant or nearly constant with respect to the changing radial position of the writing beam spot on the disc.

3. The device of claim 2, wherein control unit (98) is adapted to drive the rotation unit (92) to adjust the angular velocity when also driving the writing unit (94) to produce a guard band section (22, 38,76) comprising at least one full period of the second radial motion component (20, 50) without data marks.

4. The device of claim 1, wherein the control unit (98) is adapted to control the amount of the second slope of the first interval of the second radial motion component (20.1, 50.1) to maintain a predetermined value of at least one subspiral pitch per full turn of the rotational motion.

5. The device of claim 1, wherein the translation unit (96) comprises an acousto-optical beam deflection unit, which is connected to the writing unit (94) and to the control unit (98) and adapted to deflect the writing beam so as to move the writing beam spot on the disc in the first and second radial directions, and
wherein the control unit (98) is adapted to drive the acousto-optical beam deflection unit so as to implement the second radial motion component (20, 50) by acousto-optical deflection of the writing beam alone.

6. The device of claim 5, wherein the control unit (98) is adapted to control the acousto-optical deflection unit to translate the writing beam spot on the disc over a predetermined radial distance during the second interval of the second radial motion component, said radial distance ranging between the momentaneous radial distance to an adjacent sub-track next to be written and the sum of one metatrack pitch (42) minus or plus one sub-track pitch (40).

7. The device of claim 1, wherein the control unit (98) is adapted to provide control signals to acousto-optical deflection unit to perform the jumps (20.2, 50.2, 62, 64) with a frequency from a range of frequency values between one and the sum of the number of sub-tracks contained in the metatrack minus or plus one, counted per full turn of the rotational motion.

8. The device of claim 1, wherein the control unit (98) is adapted to provide control signals instructing the acousto-optical deflection to periodically change the radial distance bridged during the second interval of the second radial motion component (62, 64) between at least two distance values.

9. The device of claim 1, wherein the control unit (98) is adapted to drive the rotation unit (92) to generate the rotational motion comprising
a continuous first rotational motion component having a first turning sense and
periodically repeated jumps having a second turning sense opposite to the first turning sense,
and wherein the control unit is further adapted to drive the rotation unit and the translation unit to generate the jumps in the rotational motion and the jumps in the radial motion at the same time.

10. The device of claim 1, wherein the rotation unit (92) is integrated into the disc holding unit (90) such that the rotational motion is performed by rotating the disc against the writing unit (94).

11. A method for writing data marks (84) to an optical disc (64) or a master disc (64), the data marks to be arranged along at least one metatrack(30, 52, 68), which is formed by a number of coplanar parallel sub-tracks (32-38, 54-60, 70-76),
comprising a step of superposing a rotational motion and a radial motion of the disc and of a writing beam spot on the disc relative to each other,
wherein the radial motion comprises a motion component in a first radial direction and periodically repeated jumps in a second radial direction opposite to the first radial direction, and wherein the radial motion is a superposition of
a) a first radial motion component (18, 48), by which the radial position of the writing beam spot as a function of the angular position with respect to the rotational motion is changed steadily with a first slope, and
b) a periodic second radial motion component (20, 50), one period of which, plotted as a function of said angular position, is divided into
aa) a first interval (20.1, 50.1), in which the radial position of the writing beam spot changes with a second slope either in the radial direction of the first radial motion component (18, 48) or in the radial direction opposite thereto, and
bb) an adjacent second interval (20.2, 50.2), in which the radial position of the writing beam spot changes in a radial direction opposite to that of the superposition of the first (18, 48) and second radial motion components during the first interval (20.1, 50.1) with a third slope having an amount larger than the amount of the sum of the first and second slopes.

12. The method of claim 11, wherein the metatrack takes the form of a circular ring having sub-tracks in the form of parallel coplanar circular rings.

13. The method of claim 11, wherein the metatrack (30, 52, 68) takes the form of a spiral having sub-tracks (32-38, 54-60, 70-76) in the form of parallel coplanar subspirals.

14. The method of claim 11, wherein the angular velocity of the rotational motion is adjusted periodically so as to keep a channel bit time of the data marks (84) either constant or nearly constant with respect to the changing radial position of the writing beam spot on the disc.

15. The method of claim 11, comprising a step of producing a guard band section (38, 60, 76) on the disc (64) by not writing data marks during one full period of the second radial motion component (20, 50) while continuing the rotational motion and the radial motion.

16. The method of claim 14, wherein the angular velocity of the rotational motion is adjusted when producing a guard band (22) or guard band section (38, 60, 76) on the disc.

17. The method of claim 11, wherein the radial distance bridged during the second interval (60, 62) of the second radial motion component is controlled to take on a smaller first distance value when performing a jump (64) to a different sub-track (60) with data marks within a metatrack (52), and to take on a lager second distance value when performing a jump (62) to form a guard band or guard band section.

18. The method of claim 11, wherein the amount of the first slope of the first radial motion component (18, 48) amounts to one subspiral pitch (40) per full turn of the rotational motion.

19. The method of claim 11, wherein the radial distance bridged during the second interval (20.2, 50.2) of the second radial motion component (20, 50) ranges between the current radial distance (40) between the writing beam spot on the disc and an adjacent sub-track next to be written, and the radial distance defined by the sum of one metatrack pitch (42) minus or plus one sub-track pitch (40).

20. The method of claim 11, wherein the jump frequency is between one jump and a number of jumps defined by the sum of the number of sub-tracks (32-38, 54-60, 70-76) within a metatrack (30, 52, 68) minus or plus one, counted per full turn of the rotational motion.

21. The method of claim 11, wherein the second radial motion component (20, 50) is implemented by deflecting a laser beam, which forms the writing beam spot.

22. The method of claim 11, wherein the rotational motion comprises
a steady rotational motion component having a first turning sense and
periodically repeated rotational jumps having a second turning sense opposite to the first turning sense,
wherein the rotational jumps are performed at the same time as the jumps in the radial motion.

23. The method of claim 22, wherein the rotational motion is a superposition of a steady first rotational motion component, by which the angular position of the writing beam spot as a function of time is changed with a first angular velocity component, and a sawtooth-shaped second rotational motion component, and
wherein, during the first interval of radial motion, the sawtooth-shaped second rotational motion component is directed in the first turning sense with a second angular velocity component, and, during the second interval of radial motion, the sawtooth-shaped second rotational motion component is directed in the second turning sense with a third angular velocity component larger than the sum of the first and second angular velocity components.

24. An optical disc or a master disc (64) having data marks (84) arranged along a metatrack (68), which is formed by a number of coplanar parallel sub-tracks (70-76), wherein the data marks (84) are generally arranged along a respective sub-track (70-74) with at least one regular first distance (88) between adjacent data marks, as measured along a respective sub-track (70-74), and wherein the sequence of data marks (84) in each sub-track is interrupted periodically with a frequency of at least one interruption (78, 80, 82) per full turn of the disc, the interruption being formed by a larger second distance between two adjacent data marks than the respective regular first distance.

25. The disc of claim 24, wherein the data marks of adjacent sub-tracks are arranged in a two-dimensional honeycomb grid (68).

26. The disc of claim 24, wherein the metatrack takes the form of either a circular ring or a spiral (68), which is formed by a number of sub-tracks (70-76) taking the form of coplanar parallel rings or sub-spirals, respectively.
